(19) United States
(12) Patent Application Publication
(10) Pub. No.: US 2010/0207780 A1
(43) Pub. Date: Aug. 19, 2010

(54) SYSTEM AND METHOD FOR TRACKING PASSENGER LUGGAGE

(76) Inventor: Anthony James Newton, Chicago, IL (US)

Correspondence Address: Anthony J. Newton, 1700 East 84th Place, Chicago, IL, 60617, US

(21) Appl. No.: 12/693,893

(22) Filed: Jan. 26, 2010

Related U.S. Application Data
(60) Provisional application No. 61/152,895, filed on Feb. 16, 2009.

(51) Int. Cl. G08B 5/22

(52) U.S. Cl. 340/825.49

(57) ABSTRACT

A method for luggage tracking comprises: providing a tracking device having an asset number; receiving a first tracking information including initial location information from the tracking device at a starting location; updating a location of the tracking device based on the initial location information; receiving a second tracking information including updated location information from the tracking device at a destination location; and updating the location of the tracking device based on the destination location information.

The present application claims the benefit of U.S. Provisional Patent Application No. 61/152,895 entitled DEVICE FOR TRACKING AIRLINE LUGGAGE, filed on Feb. 16, 2009, which is incorporated herein by reference in its entirety.

### BACKGROUND OF THE INVENTION

The present invention generally relates to tracking passenger luggage, and more specifically relates to a system and method for tracking passenger luggage using a tracking device that is linked to a specific traveler and that transmits its location to a central system.

As the number of people traveling worldwide continues to increase, the problem of losing one's luggage is becoming a more frequent experience for travelers.

As can be seen, there is a need to better track the luggage of travelers and to decrease the number of travelers that lose their luggage.

### SUMMARY OF THE INVENTION

In one aspect of the present invention, a method for luggage tracking comprises: providing a tracking device having an asset number;

receiving a first tracking information including initial location information from the tracking device at a starting location; updating a location of the tracking device based on the initial location information; receiving a second tracking information including updated location information from the tracking device at a destination location; and updating the location of the tracking device based on the destination location information.

In another aspect of the present invention, a luggage tracking system comprises: a tracking device attachable to a luggage that transmit information regarding a location of the tracking device; a kiosk operable to receive information from a user, to associate an asset number with the tracking device, and to dispense the tracking device associated with the asset number to the user; and a central tracking database operable to receive the information from the tracking device.

These and other features, aspects and advantages of the present invention will become better understood with reference to the following drawings, description and claims.

### BRIEF DESCRIPTION OF THE DRAWINGS

FIG. 1 shows a flowchart of a method for tracking passenger luggage in accordance with an embodiment of the present invention; and

FIG. 2 shows a flowchart continuing from FIG. 1 of a method for tracking passenger luggage in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system and method for tracking passenger luggage. Luggage belonging to airline and/or train passengers may be tagged with a tracking device that communicates the location of the tagged luggage, thus helping to prevent passenger luggage from being lost during transit.

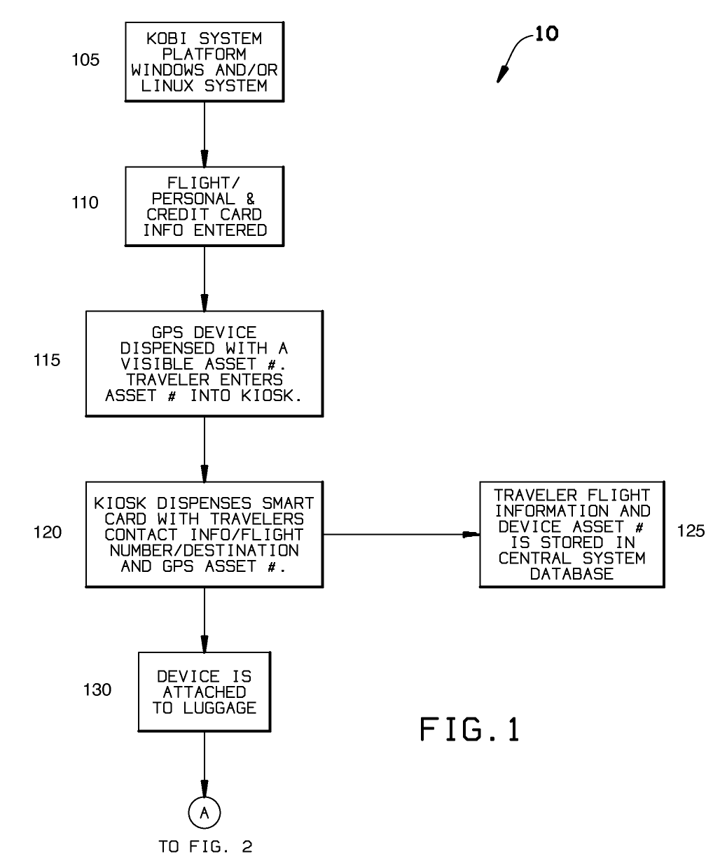

Referring now to FIG. 1, in accordance with an embodiment of the present invention, the luggage tracking system may comprise a central tracking system including a central tracking database, kiosks, tracking devices, and smart cards. In one exemplary embodiment of a method for tracking passenger luggage 10, at step 105, the luggage tracking system may be written for and implemented on WINDOWS™ and/or LINUX™ platforms and may be designed to be compatible with other transportation systems, data systems, and Global Positioning System (GPS) tracking systems. The luggage tracking system may also be integrated with billing systems and may be used to both provide real-time tracking of luggage as well as project trends regarding luggage volume for use in the travel industry. All of the information and data transmitted within the luggage tracking system may be compiled, stored, and backed up as needed and/or as requested.

At step 110, a traveler, such as a passenger on an airline or a train, may enter information, such as personal information, contact information, credit card or other payment information, and/or travel details, such as the traveler's flight/train number, travel destination, and/or other relevant itinerary information, into a kiosk. Such kiosks may be placed at train terminals, airport terminals, or any other relevant location.

At step 115, the kiosk may dispense a Global Positioning System (GPS) tracking device having a visible asset number. The tracking device may be associated with the traveler within the luggage tracking system. The traveler may enter that visible asset number into the kiosk and at step 120 the kiosk may dispense to the traveler a smart card having information such as the traveler's contact information, flight number, the traveler's destination, any ID numbers, company name or logo, time, date, and/or the asset number of the dispensed GPS tracking device embedded within the smart card. For additional security the smart card may also comprise a photo of the traveler. In one exemplary embodiment some of the traveler's personal information, such as the traveler's home address, social security number, telephone number and/or credit card information, may not be embedded within the smart card in order to protect the traveler in case the traveler misplaces and/or loses the smart card. At step 125, the central tracking database may also store all relevant information regarding the traveler, such as the traveler's flight information, the traveler's destination, and the asset number of the dispensed tracking device.

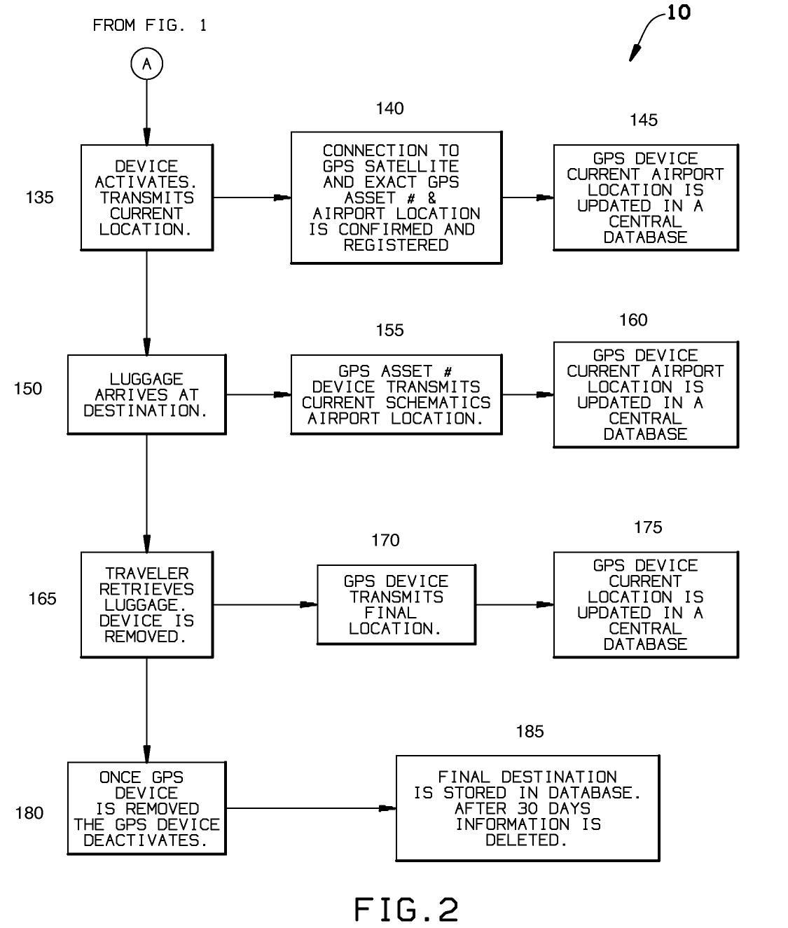

Once the tracking device is dispensed from the kiosk, the tracking device may activate and may transmit its current location. At step 130, the tracking device may be attached to a piece of luggage that the travel wishes to have tracked. Continuing on in FIG. 2, at step 135, the tracking device may activate and communicate with GPS satellites to ascertain its position and may at step 140 transmit information such as its location, including exact GPS coordinates and airport location, and its asset number to the central tracking system. The tracking device may also transmit departing airport or train station schematics to the central tracking system so that the central tracking system may know exactly where in the departing airport or train station the tracking device is located. At step 145, the central tracking system may receive the information from the tracking device and may store the information, including information of the tracking device's current airport location, into the central tracking database.

Upon departure of a plane or train that the traveler is scheduled to travel on, if the tracking device indicates that the tracked luggage is not on the departing plane or train, the luggage tracking system may be alerted by the tracking device and the luggage tracking system may then alert any operators or other personnel monitoring the luggage tracking system, such as by flashing an identification number onto the screen of an operator. Personnel at the departing point of the plane or train may also be alerted to any problems with the tracked luggage and may work to ensure that the tracked luggage makes its way to the destination of the traveler.

At step 150, when the tracked luggage arrives at the traveler's destination, the tracking device may at step 155 transmit its current location, including exact GPS coordinates and airport location, to the central tracking system. The tracking device may also transmit arriving airport or train station schematics to the central tracking system so that the central tracking system may know exactly where in the arriving airport or train station the tracking device is located. At step 160, the information transmitted from the tracking device may be stored in the central tracking database.

If the tracked luggage does not reach the baggage claims area of the airport or train station, the traveler may present the smart card at the baggage claims office in order to retrieve the tracked luggage. The baggage claims office may use the smart card to identify the traveler as well as the tracked luggage, and may use the smart card to access the luggage tracking system to locate the tracked luggage based on the location information transmitted by the tracking device.

Once the traveler retrieves the tracked luggage at the destination and, at step 165, removes the tracking device from the tracked luggage, the tracking device may at step 170 transmit its final location to the central tracking system and at step 175 the tracking device's location may be updated in the central tracking database. At step 180, the tracking device may then be deactivated. If the tracking device is not removed from the tracked luggage after arrival, the tracking device may automatically shut down thirty minutes after arrival, unless the luggage tracking system overrides the automatic shutdown.

At step 185, the final destination location of the tracking device may be stored in the central tracking database for thirty days, after which the information may be deleted from the database.

It should be understood, of course, that the foregoing relates to exemplary embodiments of the invention and that modifications may be made without departing from the spirit and scope of the invention as set forth in the following claims.

We claim:

1. A method for luggage tracking comprising:
providing a tracking device having an asset number;
receiving a first tracking information including initial location information from the tracking device at a starting location;
updating a location of the tracking device based on the initial location information;
receiving a second tracking information including updated location information from the tracking device at a destination location; and
updating the location of the tracking device based on the destination location information.

2. The method of claim 1, further comprising:
associating a user traveling from the starting location to the destination location with the asset number of the tracking device;

3. The method of claim 2, wherein the tracking device is attachable to and tracks a piece of luggage of the user.

4. The method of claim 2, further comprising:
providing a smart card associated with the user and the asset number.

5. The method of claim 1, further comprising:
activating the tracking device upon providing the tracking device; and
automatically deactivating the tracking device after arrival of the tracking device at the destination location.

6. The method of claim 1, further comprising:
receiving a final tracking information including final location information from the tracking device at a final destination.

7. The method of claim 1, wherein:
the receiving the first tracking information further comprises receiving a first schematic of a starting airport location; and
the receiving the second tracking information further comprises receiving a second schematic of a destination airport location.

8. A luggage tracking system comprising:
a tracking device attachable to a piece of luggage that transmits information regarding a location of the tracking device;
a kiosk operable to receive information from a user, to associate an asset number with the tracking device, and to dispense the tracking device associated with the asset number to the user; and
a central tracking database operable to receive the information from the tracking device.

9. The system of claim 8, wherein:
the tracking device transmits the information to the central tracking database.

10. The system of claim 9, wherein:
the tracking device transmits, at a starting location, the starting location of the tracking device to the central tracking database and, at a destination location, transmits the destination location of the tracking device to the central tracking database.
